(19) United States
(12) Patent Application Publication
(10) Pub. No.: US 2001/0052580 A1
(43) Pub. Date: Dec. 20, 2001

(54) Method and apparatus for exposing stimulable phosphor sheet

(76) Inventor: Taizo Akimoto, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/747,929

(22) Filed: Dec. 27, 2000

(30) Foreign Application Priority Data
Dec. 27, 1999 (JP) 370046/1999

(51) Int. Cl. G21G 4/00

(52) U.S. Cl. 250/493.1

(57) ABSTRACT

The resolution of a stimulable phosphor sheet is improved by applying a magnetic field to the stimulable phosphor sheet in the direction perpendicular to the surface plane thereof, e.g., by using a pair of magnets, while exposing the stimulable phosphor sheet to radiation from radioactive isotopes. The magnetic field may be applied by using a superconducting coil, instead of using the magnets. An electrical field may also be applied instead of or in addition to the magnetic field. As the travel paths of charged particles are wound and focused, expansion of the size of the beam spots (the areas whereon radiation emitted by the radioactive isotopes has been recorded) is restrained.

### BACKGROUND OF THE INVENTION

1. Field of the Invention

The present invention relates to a method and apparatus for exposing a stimulable phosphor sheet, and more specifically to a technique for recording on a stimulable phosphor sheet positions at which charged particles have collided with the stimulable phosphor particles embedded within the stimulable phosphor sheet. Said positions are hereinafter generally referred to as “collision positions”. The term “stimulable phosphor sheet” refers to a phosphor sheet which absorbs and accumulates radiation energy when exposed to radiation and which emits the accumulated radiation energy as light in the manner of stimulated emission when subsequently irradiated with stimulating light such as a laser beam having a certain wavelength range. A typical example of a well-known stimulable phosphor sheet, which is known also as a radiation inverting panel utilizes a phosphor which exhibits stimulated emission, and is constituted of a base sheet coated with a layer of a material composed of a binder and stimulable phosphor particles such as BaFX particles (X represents a halogen atom) dispersed in the binder at a high density. The term “radiation” refers to a beam of particles emitted from radioactive isotopes. The term “charged particle” refers to a particle which is emitted from the radioactive isotope and which is affected by a surrounding magnetic and/or electrical field. The verb “expose” refers to exposing the stimulable phosphor sheet to the radiation, i.e., having the charged particles emitted from the radioactive isotopes collide with the stimulable phosphor sheet. The verb “record” refers to recording the collision positions so that those positions can be read out afterward.

2. Description of the Related Art

As it has been difficult to directly observe the radiation or the beam of charged particles emitted from radioactive isotopes, techniques utilizing the stimulable phosphor sheet have been heretofore developed for thereby identifying positions of the radioactive isotopes dispersed on a specified surface.

The stimulable phosphor sheet accumulates the radiation energy at exposed positions thereon, i.e., at positions where the charged particles have collided with the stimulable phosphor particles within the stimulable phosphor sheet, and emits the accumulated radiation energy as the light from those positions in the manner of stimulated emission when irradiated with stimulating light such as a laser beam having a certain wavelength range. The light emitted from the stimulable phosphor sheet may be converted to an electrical signal using a photoelectric converting element to enable detection thereof. Accordingly, the positions of the radioactive isotopes can be detected as the origins of stimulated emission on the stimulable phosphor sheet.

An analysis method utilizing a micro-array has been used for analyzing gene expression and the like. As will be described in detail in the following, the term “micro-array”may refer to any of a variety of array chips, including a macro-array having a relatively large size, a tiny DNA chip etc.

A method for analyzing gene expressions using the micro-array is described in detail in the paper titled “Gene Expression Analysis Using the Micro-Array” (Experimental Medical Science Series Vol. 17; p.1-5; Yodosha Shuppann, Inc. (January, 1999)).

As shown in FIG. 9, the technique of gene expression analysis using the micro-array, which has recently come into wide use, utilizes a base plate 70 (e.g., a silicon base plate) on surface of which a plurality of kinds of organic molecules (frequently used are, e.g., c-DNA, oligo-DNA, other types of DNA, PNA and EST) are arranged and fixed in matrix using a spotter etc. Such a base plate carrying plural kinds of organic molecules arranged and fixed in a matrix may be referred to as either of a variety of names (e.g., a macro-array, a micro-array or a DNA chip) according to the type of the base plate etc. In this specification, however, they are generically referred to as “micro-arrays.”

The analysis method using the micro-array requires use of additional organic molecules (e.g., molecules of c-DNA, genome-DNA, m-RNA, total-RNA, other types of RNA, dNTP or PNA) marked with radioactive isotope, fluorescent dye, etc.

In the analysis, these additional organic molecules marked with the radioactive isotopes etc. are hybridized with those organic molecules fixed in the matrix on the micro-array.

At those spots on the micro-array carrying the fixed organic molecules capable of being hybridized (or combined) with the additional organic molecules, two groups of the organic molecules hybridize with each other and thereby a marker such as the radioactive isotope is fixed thereon. On the other hand, a marker cannot be fixed at those spots where none of the organic molecules provided thereon is capable of being hybridized with the additional organic molecules. Double circles in FIG. 9 schematically indicate the positions in the micro-array where the hybridized organic molecules are fixed, i.e., the positions where a marker is fixed. Although each of the array-points arranged in the matrix is clearly separated from others for explanatory purposes in FIG. 9, each of the array-points can hardly be distinguished visually from others in practice as they are very small and arranged in close proximity to each other at a high density.

The position of a hybridized organic molecule in the micro-array can be identified by detecting the position where a marker such as a radioactive isotope resides. Subsequently, the type of a hybridized organic molecule can be identified based on the identified position thereof.

An advantage of using radioactive isotopes as the marker as opposed to fluorescent dyes for the same purpose is an improvement in sensitivity. On the other hand, because it is impossible to detect the positions of the radioactive isotopes directly, their use is problematic.

The stimulable phosphor sheet has been used in a detection method intended to overcome the above problem. In this method, the stimulable phosphor sheet is overlaid with the micro-array after hybridization on which radioactive isotopes are fixed so that the stimulable phosphor sheet is exposed to the radiation emitted from the radioactive isotopes, i.e., so that the charged particles emitted from the radioactive isotopes collide with the stimulable phosphor sheet. The stimulable phosphor sheet stores the radiation energy at those spots exposed to the radiation, i.e., at those spots where the charged particles have collided. Those spots become capable of emitting stimulated emission when irradiated with a stimulating light such as a laser beam having a certain wavelength range. The verb “record” as used herein refers to causing such a change in the physical state of the stimulable phosphor sheet. Information carried by those spots exposed to the radiation on the stimulable phosphor sheet is read out afterward by projecting the stimulating laser beam capable of inducing stimulated emission, i.e., the information recorded on the stimulable phosphor sheet is read out as data descriptive of the positions where the stimulated emission occurs.

Recently, the market for micro-arrays capable of carrying many detection targets, e.g., many organic molecules within a small area has been growing. Thus, a need has been generated for the stimulable phosphor sheet with improved resolutions.

One factor hindering improvement in the resolution of the stimulable phosphor sheet is horizontal dispersion of the charged particles emitted from the radioactive isotopes. The stimulable phosphor sheet has a layer of material composed of binder and stimulable phosphor particles dispersed in the binder at a high density. The layer has a certain thickness. The travel direction of a charged particle changes upon collision with the stimulable phosphor particles contained within the layer thereof, and thereby comes to have a horizontal velocity component. Accordingly, the deeper the charged particles travels into the layer, the larger the beam spot of the charged particles expands. The charged particles are thus dispersed in horizontal directions as they travel through the layer, causing the areas (i.e., the beam spots) on which radiation energy has been recorded to become diffuse. The degree of the horizontal dispersion of the charged particles may encompass a considerable deviation from the travel-path trajectory at which the particles enter the sheet, depending on the thickness of the layer the particles pass through. Therefore, when the stimulable phosphor sheet is exposed to the laser beam for readout, the stimulated emissions are emitted from larger beam spots on the stimulable phosphor sheet as diffused light as opposed to smaller beams spots as concentrated light, thereby reducing the resolution of the stimulable phosphor sheet.

Improvement in the resolution of the stimulable phosphor sheet is a prerequisite to increasing the array-point density of the micro-array.

### SUMMARY OF THE INVENTION

The purpose of the present invention is to prevent the reduction of the resolution of the stimulable phosphor sheet by restraining the horizontal dispersion of the charged particles, and thereby to provide a method and an apparatus for exposing the stimulable phosphor sheet realizing improved resolution.

In the method of the present invention, a stimulable phosphor sheet is exposed to a beam of charged particles to record thereon collision positions at which the charged particles have collided with the stimulable phosphor sheet, wherein the stimulable phosphor sheet is exposed to the charged particles while an electrical and/or magnetic field is applied to the stimulable phosphor sheet in a direction perpendicular to a surface plane of the stimulable phosphor sheet.

When a charged particle enters a stimulable phosphor sheet whereon a magnetic field in the direction perpendicular to the surface plane thereof is applied, an effect of the Lorentz force causes the charged particle to travel in a spiral motion through the sheet. The horizontal dispersion of the charged particle is thereby restrained, and the travel path of the charged particle is constrained in a small horizontal range. Accordingly, the level of the reduction in resolution due to horizontal dispersion can be lowered.

When a charged particle enters a stimulable phosphor sheet whereon application of an electrical field in the direction perpendicular to the surface plane thereof is applied, the motion of the charged particle toward the opposite side of the stimulable phosphor sheet is accelerated by an effect of the electrical field. The scope of the horizontal dispersion of the charged particle is thus narrowed because of the acceleration of the charged particle in the direction perpendicular to the surface plane, which constrains the travel path of the charged particle in a narrow horizontal range. Accordingly, the level of the reduction in resolution due to horizontal dispersion can be lowered.

The level of the reduction in resolution due to horizontal dispersion may further be lowered by applying both the electrical and the magnetic field concurrently to advantageously obtain a combined effect.

The present invention also provides a novel stimulable phosphor sheet comprising a matrix frame made of a ferromagnetic material defining a plurality of cells and masses of stimulable phosphor particles, each mass being fixed using binder in one of the cells defined by the matrix frame.

When using the above stimulable phosphor sheet together with the exposure method in which the magnetic field is applied to the stimulable phosphor sheet, a charged particle entering one of the cells defined by the matrix frame travels only within that single cell all the way through the layer. Accordingly, the undesired exposure of adjacent stimulable phosphor particles caused by horizontal dispersion of the charged particle can be effectively reduced.

The present invention also provides a novel exposure apparatus for exposing a stimulable phosphor sheet comprising a holder table for holding the stimulable phosphor sheet overlaid with a micro-array on which radioactive isotopes are distributed and fixed, and an apparatus for applying an electrical and/or magnetic field onto a surface of the holder table in the direction perpendicular to the surface of the holder table.

The above apparatus can be used to carry out the method described above to reduce the occurrence of the undesired exposure of the adjacent stimulable phosphor particles due to horizontal dispersion. Thereby, it becomes possible to increase the array-point density of the micro-array.

The method and apparatus of the present invention are effective in reducing the occurrence of the undesired exposure of the adjacent stimulable phosphor particles, and thus the level of the reduction in resolution due to horizontal dispersion. Accordingly, the positions where the radioactive isotopes reside are detected accurately, and the accuracy of analysis employing radioactive isotopes, e.g., the analysis using the micro-array is thereby improved.

In addition, it is possible to further improve the resolution of the stimulable phosphor sheet and the accuracy of analysis by using the stimulable phosphor sheet of the present invention in combination with the method or apparatus of the present invention.

### BRIEF DESCRIPTION OF THE DRAWINGS

FIG. 1 shows major sections of an exposure apparatus according to the first embodiment of the present invention,

FIG. 2 shows major portions of another exposure apparatus according to the first embodiment of the present invention,

FIG. 3 shows major sections of an exposure apparatus according to the second embodiment of the present invention,

FIG. 4 shows major sections of an exposure apparatus according to the third embodiment of the present invention,

FIG. 5 schematically shows the travel paths of the charged particles colliding with stimulable phosphor particles dispersed in a stimulable phosphor sheet whereon a magnetic field is not applied,

FIG. 6 schematically shows the travel paths of the charged particles colliding with stimulable phosphor particles dispersed in a stimulable phosphor sheet whereon a magnetic field is applied,

FIG. 7 is a plane view of the stimulable phosphor sheet carrying masses of stimulable phosphor particles, each mass being fixed using binder in one of the cells defined by the matrix frame,

FIG. 8 is a side view of the stimulable phosphor sheet provided with a decelerating layer, and

FIG. 9 schematically shows a micro-array on which radioactive isotopes are distributed and fixed.

### DESCRIPTION OF THE PREFERRED EMBODIMENTS

Now, embodiments of the present invention will be described with reference to the accompanying drawings.

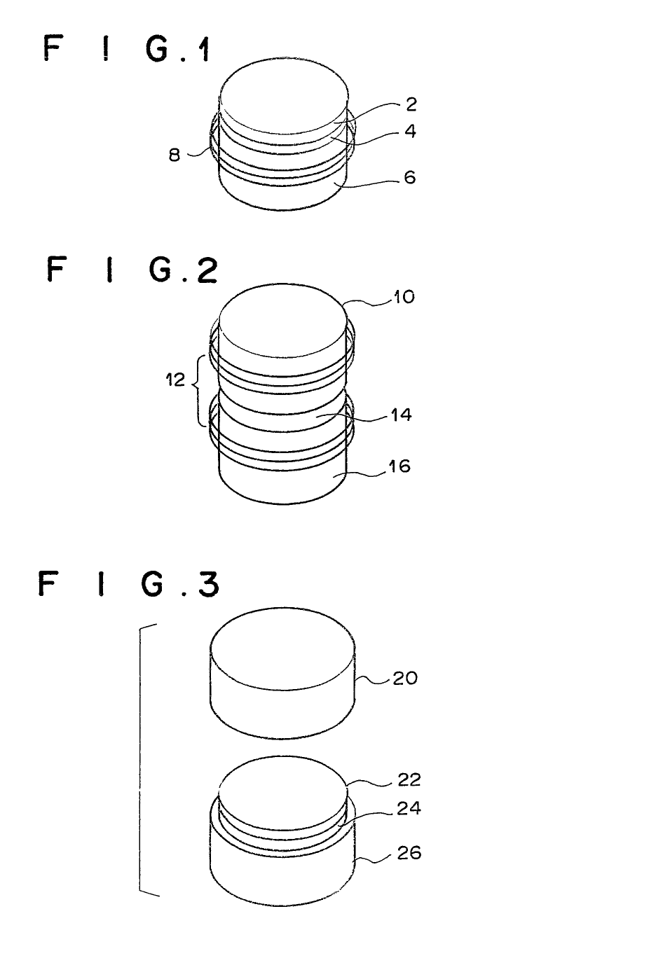

FIG. 1 shows major sections of an exposure apparatus according to the first embodiment of the present invention. Identified with the reference numbers 6 and 8 are a hollow core and a superconducting coil wound around the hollow core, respectively. The top face of the core 6 functions as a sample holding face for holding thereon a stimulable phosphor sheet 4 to be exposed. In FIG. 1, a micro-array 2 on which radioactive isotopes are distributed and fixed is overlaid on a surface of the stimulable phosphor sheet 4 so that the stimulable phosphor sheet 4 is exposed to the radiation emitted from the radioactive isotopes fixed in the micro-array 2, though the stimulable phosphor sheet 4 may instead be exposed to the radiation which is emitted from a radiation source placed at a position separated from the stimulable phosphor sheet 4 and which reaches the stimulable phosphor sheet 4 after traveling through the gap between the radiation source and the stimulable phosphor sheet 4. The superconducting coil 8 generates a magnetic field which is applied to the sample holding face at the top of the core 6 at the perpendicular direction to the sample holding face. Though it is shown only partially in FIG. 1 for the sake of clarity of the figure, the superconducting coil 8 is wound around the entire portion of the core 6, and is cooled.

FIG. 2 shows major portions of another exposure apparatus according to the first embodiment of the present invention. Identified with the reference numbers 10, 16 and 12 are an upper core, a lower core and a superconducting coil, respectively. The superconducting coil 12 is actually coiled around the entire portion between the top face of the upper core 10 and the lower end face of the lower core 16, though it is shown only partially in FIG. 2 for the sake of clarity of the figure. The lower core 16 is fixed on a base (not shown), while the upper core 10 can be freely moved vertically with respect to the base. A gap 14 is maintained between the bottom face of the upper core 10 and the upper face of the lower core 16 even when the upper core 10 is lowered to the lowest possible position thereof. The upper face of the lower core 16 functions as a sample holding face for holding thereon the stimulable phosphor sheet.

In the apparatus shown in FIG. 2, the stimulable phosphor sheet is exposed to the radiation emitted from the radioactive isotopes fixed on the micro-array. Such a style of exposure is realized by superposing the micro-array having the radioactive isotopes onto the stimulable phosphor sheet, and placing the stimulable phosphor sheet and the micro-array overlaid thereon together on the top face of the lower core 16, lowering the upper core 10 to a predetermined level, and supplying electric current to the superconducting coil 12. Supply of electric current to the superconducting coil is stopped after a required exposure period, and thereafter the upper core 10 is raised to remove the stimulable phosphor sheet from the apparatus. Through the above exposure process, the positions where the radioactive isotopes reside is recorded on the stimulable phosphor sheet.

If necessary, a source of erasing light (the source of the stimulating laser beam may concurrently act as the source of the erasing light) may be provided for restoring the stimulable phosphor sheet to the unexposed state thereof by projecting the erasing light onto the stimulable phosphor sheet between the steps of placing the micro-array and the stimulable phosphor sheet on the top face of the lower core 16, and lowering the upper core 10 to the predetermined level. The source of the erasing light may be used also with the apparatus shown in FIG. 1, i.e., the stimulable phosphor sheet 4 may be restored to the unexposed state thereof by projecting the erasing light onto the stimulable phosphor sheet 4 between the steps of placing the micro-array 2 and the stimulable phosphor sheet 4 on the top face of the core 6 and exposing the stimulable phosphor sheet 4 for a predetermined exposure period.

The mechanism by which the resolution of the stimulable phosphor sheet is improved will now be described with reference to FIGS. 5 and 6. The upper halves of FIGS. 5 and 6 schematically illustrate travel paths of the charged particles within the layer of a material containing stimulable phosphor particles. Some of the charged particles collide with the stimulable phosphor particles and are dispersed in horizontal directions. The lower halves of FIGS. 5 and 6 are cross-sectional views of the travel paths. FIG. 5 illustrates the travel paths of the charged particles colliding with the stimulable phosphor particles within the layer of a material whereon a magnetic field is applied, in which each of the charged particles collides with the stimulable phosphor particles within an area 42, and is deflected in a horizontal direction as indicated by an arrow 40. On the other hand, FIG. 6 illustrates the travel paths of the charged particles colliding with the stimulable phosphor particles within the layer of a material whereon a magnetic field is applied, in which each of the charged particles follows a spiral path through the sheet as indicated by an arrow 44 because of a lateral circular motion component thereof induced by the Lorentz force from the magnetic field. Accordingly, the area where the charged particles collide with the stimulable phosphor particles is limited to an area (beam spot) 46, which is smaller than the area (beam spot) 42.

As is obvious from comparison between FIGS. 5 and 6, the scope of the horizontal dispersion of the charged particles traveling through the stimulable phosphor sheet 4 whereon a magnetic field is applied is limited to the relatively small beam spot 46, while the scope of the horizontal dispersion (the size of the area exposed, i.e., the beam spot) would become larger upon without application of the magnetic field to the stimulable phosphor sheet, even if the energy and the angle of incidence of each charged particle were the same.

According to the apparatus shown in FIG. 1 or 2, expansion of the size of the beam spot can be restrained to provide a more focused exposure of the positions corresponding to the spots where the radioactive isotopes reside on the micro-array overlaid onto the stimulable phosphor sheet 4 whereon a magnetic field is applied in the direction perpendicular to the surface plane of the stimulable phosphor sheet 4. Consequently, the resolution of the stimulable phosphor sheet is improved and false detection can be avoided even if the array-point density of the micro-array 2 is increased.

FIG. 3 shows an exposure apparatus according to the second embodiment of the present invention. This apparatus comprises a pair of permanent magnets (Sm—Co rare earth magnets) 20 and 26, which may be replaced by a single lower permanent magnet. The magnets 20 and 26 face each other maintaining a very small separation between the faces thereof, though they are shown with a large separation in FIG. 3 for the sake of clarity. A sample consisting of a stimulable phosphor sheet 24 and a micro-array 22 overlaid thereon is inserted from a side into the separation between the magnets 20 and 26. A pair of neodymium-containing magnets or Alnico magnets may also be adopted as the magnets 20 and 26.

According to the apparatus shown in FIG. 3, the beam spot size is again limited to a relatively small size, as the stimulable phosphor sheet 24 is exposed to the radiation emitted from the radioactive isotopes fixed on the micro-array 22 whereon a magnetic field is applied in the direction perpendicular to the surface plane of the stimulable phosphor sheet 24.

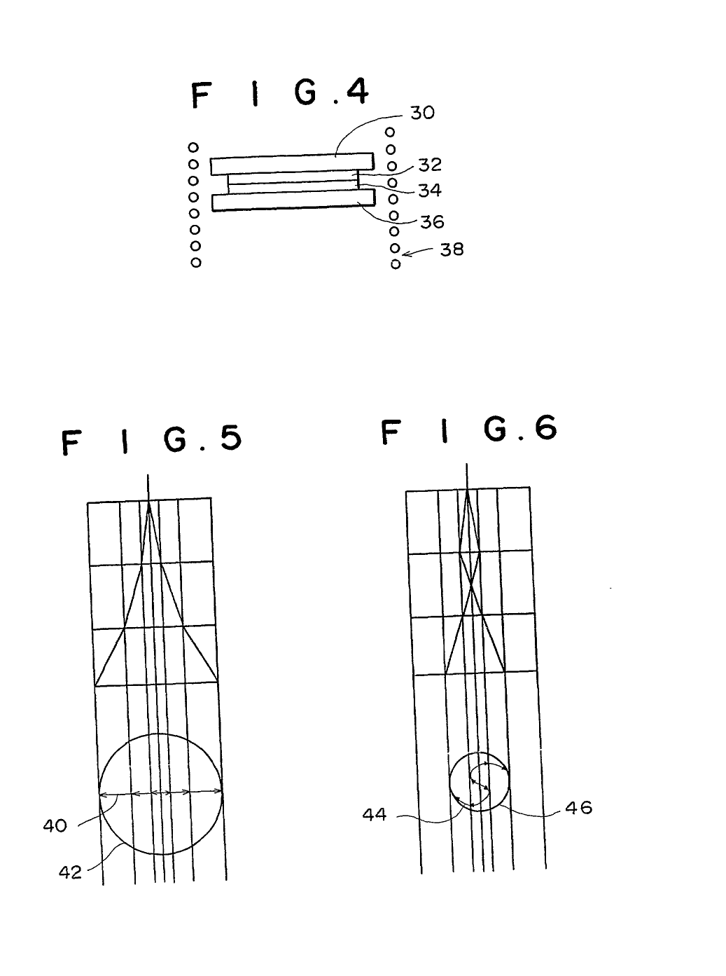

FIG. 4 shows an exposure apparatus according to the third embodiment of the present invention. In this apparatus, a micro-array 32 on which radioactive isotopes are distributed and fixed and a stimulable phosphor sheet 34 overlaid with the micro-array 32 are held between a pair of electrodes 30 and 36 so that an electric field perpendicular to the surface plane of the stimulable phosphor sheet 34 is applied during the exposure process in addition to the magnetic field. The upper electrode 30 is charged with a negative charge and the lower electrode 36 is charged with a positive charge. Thus, the charged particles carrying negative charge are accelerated toward the lower electrode 36. The magnetic field perpendicular to the surface plane of the stimulable phosphor sheet 34 is still applied by a superconducting coil 38 wound around the electrodes 30 and 36.

The size of the beam spots is decreased when an electric field which accelerates the charged particles toward the lower electrode 36 is applied, as a vertical velocity component (i.e., a component in the vertical direction in FIG. 4) of the charged particles is magnified by the electric field, and the effect of horizontal dispersion caused by collisions between the charged particles and stimulable phosphor particles is lessened. That is to say, the charged particles accelerated by the electric field pass through the stimulable phosphor sheet 34 before being dispersed significantly in horizontal directions. Consequently, the resolution of the stimulable phosphor sheet 34 is improved. In the apparatus for exposing shown in FIG. 4, the magnetic field is applied by the superconducting coil 38, in addition to the electric field applied by the electrodes 30 and 36 so that expansion of the size of the beam spots is restrained most effectively under application of both the magnetic field and the electric field.

As the electric field independently restrains the expansion of the range of exposure, the apparatus shown in FIG. 4 still works effectively without use of the superconducting coil 38.

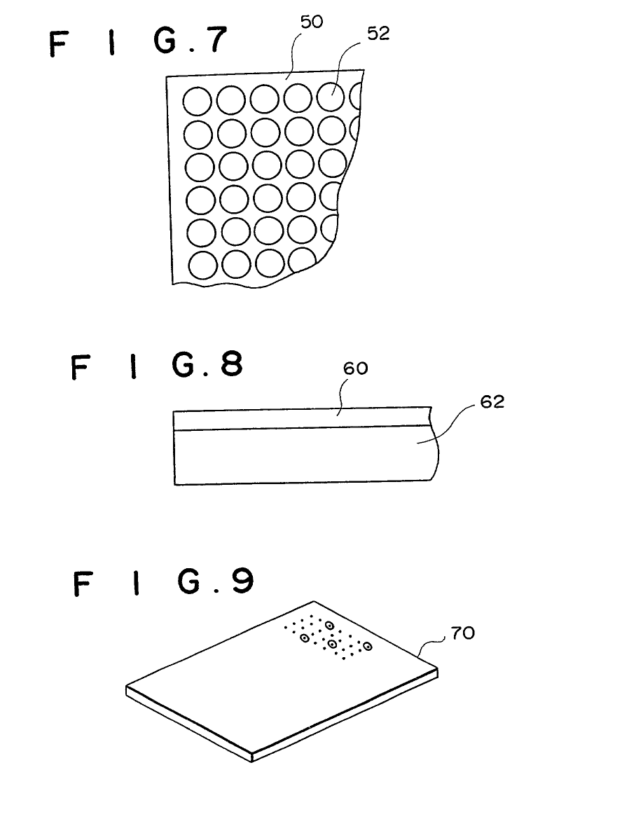

Now, a stimulable phosphor sheet contrived to improve the resolution thereof will be disclosed in the following. Shown in FIG. 7 is a plane view of a stimulable phosphor sheet carrying masses of stimulable phosphor particles, each mass being fixed by binder in one of the cells defined by a ferromagnetic matrix frame 50. That is to say, the matrix frame 50 can be considered as a cellular sheet carrying in each cell a mass 52 of the stimulable phosphor particles dispersed in the binder at a high density.

Although there has been a known technique of using a matrix frame made of Pb etc., which absorbs horizontally dispersed electrons to reduce the effect of the horizontal dispersion, such a matrix frame has a problem of decreasing the sensitivity of the stimulable phosphor sheet.

When exposing the stimulable phosphor sheet shown in FIG. 7 to radiation while applying the magnetic field thereto using the apparatus shown in any of FIGS. 1-4, each charged particle entering a cell defined by the matrix frame 50 travels within only that cell, and passes through the sheet exhibiting a spiral motion due to an effect of the Lorentz force caused by the strong perpendicular magnetic field induced by the ferromagnetic matrix frame 50. Although each charged particle is still dispersed in horizontal directions to some degree, in comparison to cases in which a magnetic field is not applied it becomes very rare that a charged particle travels into adjacent cells to expose the stimulable phosphor particles therein, and the resolution of the stimulable phosphor sheet is improved. FIG. 7 shows an example of a continuous high-intensity ferromagnetic matrix frame 50, which defines the cells, each containing a mass of the stimulable phosphor particles. Alternatively, separate pieces of a high-intensity ferromagnetic material may be disposed in the stimulable phosphor sheet to produce the same effect of the ferromagnetic matrix frame 50.

Shown in FIG. 8 is a stimulable phosphor sheet provided with a deceleration layer 60 on the surface thereof. The magnetic field applied thereto may be too weak to sufficiently restrain the horizontal dispersion (as explained in reference to FIG. 6) of the charged particles emitted from the radioactive isotopes if the energy of the charged particles exceeds a certain level. To overcome this problem, the deceleration layer 60 is provided on the surface of the stimulable phosphor sheet 62 for decelerating the charged particles before the charged particles enter the stimulable phosphor sheet 62. That is to say, the charged particles encounter the stimulable phosphor sheet 62 after being decelerated by the deceleration layer 60.

Thereby, the expansion of the size of the beam spots is sufficiently limited (as explained in reference to FIG. 6) and the resolution of the stimulable phosphor sheet is improved. When a thin layer of GaAs coated with CsO or the like is selected as the deceleration layer 60, an additional beam of electrons is generated through ionization of the deceleration layer 60 during deceleration of the charged particles, and the stimulable phosphor sheet 62 is further exposed to the additional beam of the electrons. That is to say, the deceleration layer 60 of such a type also has a sensitizing effect.

Finally, results of several experiments will be given as examples in the following. In one experiment, energy of a charged particle (an electron in this example) was 50 keV and a magnetic field of 76,000 Gauss was applied to the stimulable phosphor sheet in the direction perpendicular to the surface plane thereof, under which the charged particle is supposed to exhibit a spiral motion having a circular motion component with a 0.1 mm radius. Consequently, the expansion of the size of the beam spots was sufficiently limited (as explained in reference to FIG. 6), and the resolution of the stimulable phosphor sheet was thereby improved.

In another experiment, ³²P which is capable of emitting a beam of charged particles (i.e., beta-rays) with the maximum energy per particle of 1.6 MeV was selected as the radioactive isotope, and the stimulable phosphor sheet as shown in FIG. 8 was exposed to the beam so that the beam would enter the stimulable phosphor sheet 62 after being decelerated by the deceleration layer 60. A 100,000 Gauss magnetic field was applied in the direction perpendicular to the surface plane of the stimulable phosphor sheet 62. Consequently, the expansion of the size of the beam spots was sufficiently limited (as explained in reference to FIG. 6), and the resolution of the stimulable phosphor sheet was thereby improved. Further, the sensitivity of the stimulable phosphor sheet was also improved.

Although some of the embodiments of the present invention have been described hereinbefore, a variety of alternative embodiments are possible without deflecting from the scope of the attached claims.

In addition, all of the contents of Japanese Patent Application No. 11(1999)-370046 are incorporated into this specification by reference.

What is claimed is:

1. A method for exposing a stimulable phosphor sheet to radiation emitted by charged particles to record thereon collision positions at which the charged particles have collided with the stimulable phosphor sheet, wherein
the stimulable phosphor sheet is exposed to the radiation emitted by the charged particles while an electrical and/or magnetic field in a direction perpendicular to a surface plane of the stimulable phosphor sheet is applied thereon.

2. A stimulable phosphor sheet comprising
a matrix frame made of a ferromagnetic material defining a plurality of cells, and
masses of stimulable phosphor particles, each mass being fixed using binder in one of the cells defined by the matrix frame.

3. An apparatus for exposing a stimulable phosphor sheet comprising
a holder table for holding the stimulable phosphor sheet overlaid with a micro-array on which radioactive isotopes are distributed and fixed, and
an apparatus for applying an electrical and/or magnetic field onto a surface of the holder table in a direction perpendicular to the surface of the holder table.
